(19) United States
(12) Patent Application Publication
(10) Pub. No.: US 2017/0138871 A1
(43) Pub. Date: May 18, 2017

(54) Estimating Subterranean Fluid Viscosity Based on Nuclear Magnetic Resonance (NMR) Data

(71) Applicant: HALLIBURTON ENERGY SERVICES, INC., Houston, TX (US)

(72) Inventors: Lilong Li, Humble, TX (US); Magdalena Traico Sandor, Humble, TX (US); Songhua Chen, Katy, TX (US)

(73) Assignee: HALLIBURTON ENERGY SERVICES, INC., Houston, TX (US)

(21) Appl. No.: 14/429,254

(22) PCT Filed: Apr. 10, 2014
(86) PCT No.: PCT/US2014/033627

§ 371 Date: Mar. 18, 2015

(51) Int. Cl. G01N 24/08; G01V 3/32

(52) U.S. Cl. CPC G01N 24/081; G01V 3/32

(57) ABSTRACT

Systems, methods, and software for estimating the viscosity of a subterranean fluid based on NMR logging data are described. In some aspects, a viscosity model relates subterranean fluid viscosity to apparent hydrogen index. An apparent hydrogen index value for a subterranean region is computed based on nuclear magnetic resonance (NMR) logging data acquired from a subterranean region. A subterranean fluid viscosity value is computed for the subterranean region based on the viscosity model and the apparent hydrogen index value.

### BACKGROUND

This specification relates to estimating subterranean fluid viscosity based on nuclear magnetic resonance (NMR) data associated with a subterranean region.

In the field of logging (e.g., wireline logging, logging while drilling (LWD) and measurement while drilling (MWD)), nuclear magnetic resonance (NMR) tools have been used to explore the subsurface based on the magnetic interactions with subsurface material. Some downhole NMR tools include a magnet assembly that produces a static magnetic field, and a coil assembly that generates radio frequency (RF) control signals and detects magnetic resonance phenomena in the subsurface material.

### DESCRIPTION OF DRAWINGS

FIG. 1A is a diagram of an example well system.

FIG. 1B is a diagram of an example well system that includes an NMR logging tool in a wireline logging environment.

FIG. 1C is a diagram of an example well system that includes an NMR logging tool in a logging while drilling (LWD) environment.

FIG. 2 is a diagram of an example mapping function.

FIG. 3 is an example plot of apparent hydrogen index values versus 1/T_{2GM}.

FIG. 4 is a diagram of an example process for estimating the viscosity of a subterranean region based on NMR logging data.

FIG. 5 is a diagram of an example process for selecting an inter-echo time for estimating the viscosity of a subterranean region.

FIG. 6 is a plot that shows measured viscosity values compared to predicted viscosity values for several example subterranean regions.

FIG. 7 is a diagram of an example computer system.

### DETAILED DESCRIPTION

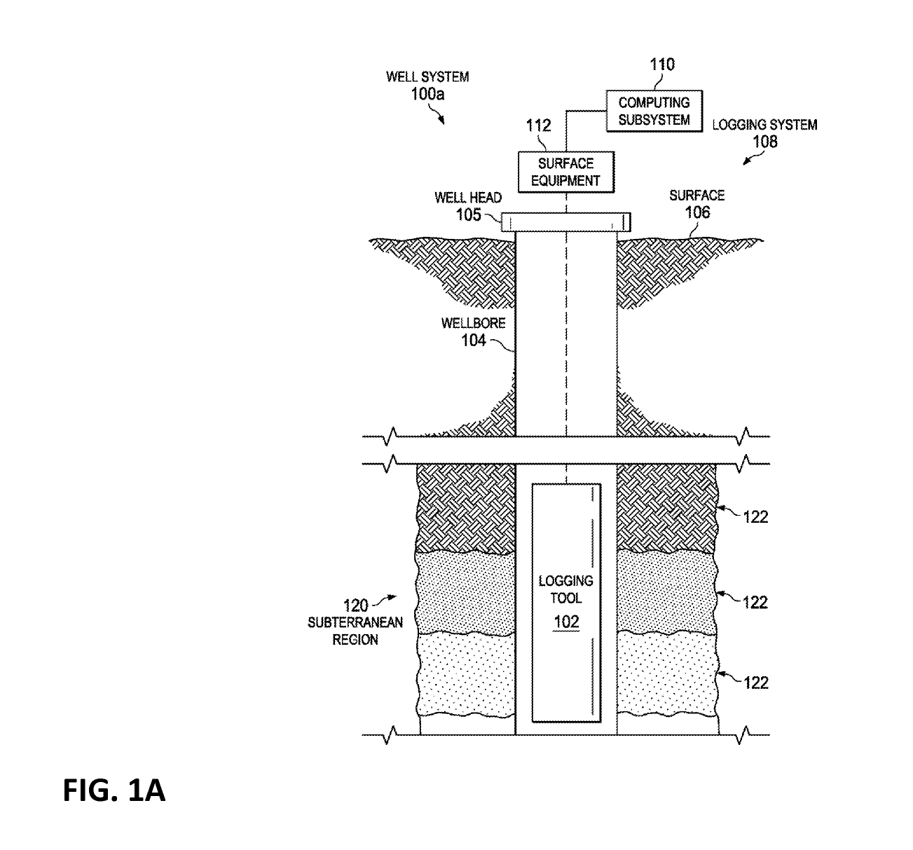

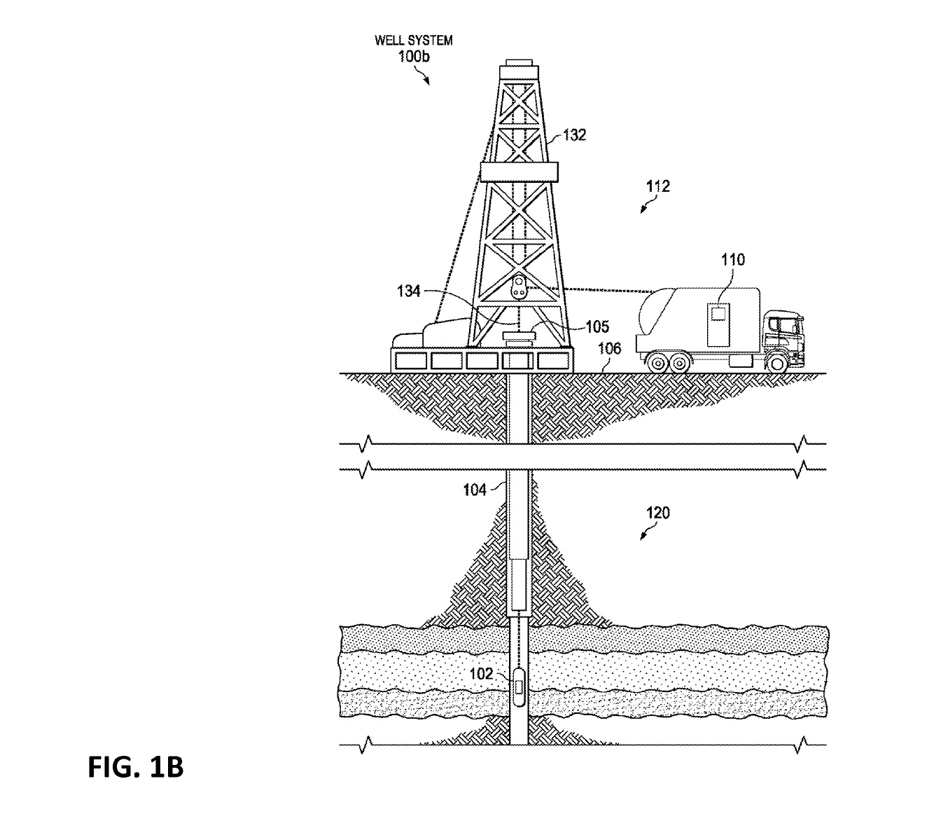

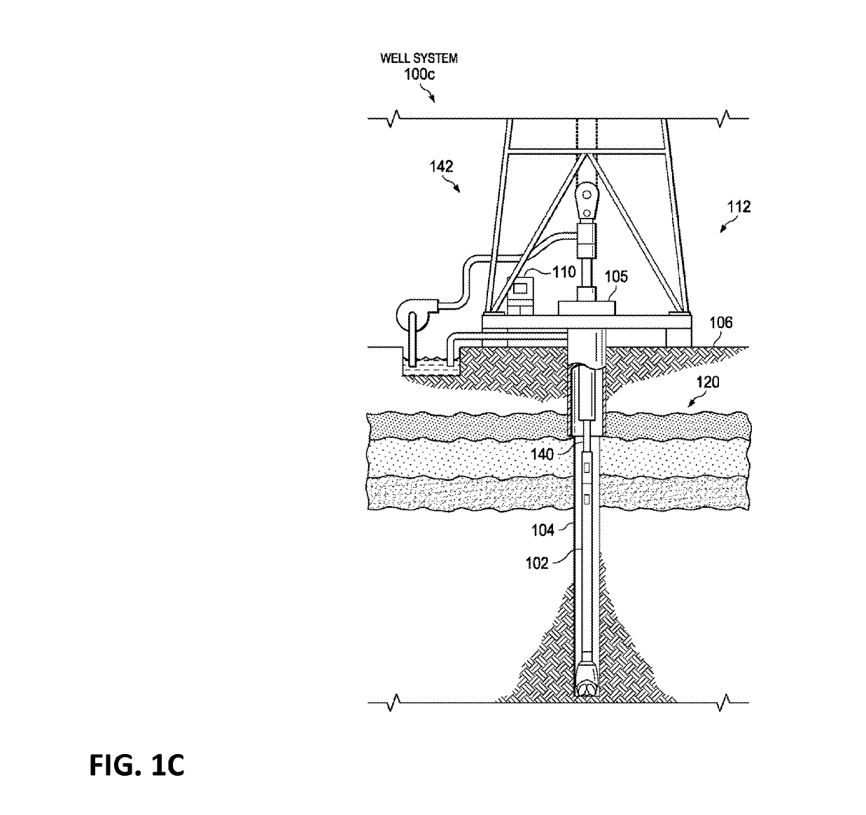

FIG. 1A is a diagram of an example well system 100a. The example well system 100a includes an NMR logging system 108 and a subterranean region 120 beneath the ground surface 106. A well system can include additional or different features that are not shown in FIG. 1A. For example, the well system 100a may include additional drilling system components, wireline logging system components, etc.

The subterranean region 120 can include all or part of one or more subterranean formations or zones. The example subterranean region 120 shown in FIG. 1A includes multiple subsurface layers 122 and a wellbore 104 penetrated through the subsurface layers 122. The subsurface layers 122 can include sedimentary layers, rock layers, sand layers, or combinations of these and other types of subsurface layers. One or more of the subsurface layers can contain fluids, such as brine, oil, gas, etc. Although the example wellbore 104 shown in FIG. 1A is a vertical wellbore, the NMR logging system 108 can be implemented in other wellbore orientations. For example, the NMR logging system 108 may be adapted for horizontal wellbores, slanted wellbores, curved wellbores, vertical wellbores, or combinations of these.

The example NMR logging system 108 includes a logging tool 102, surface equipment 112, and a computing subsystem 110. In the example shown in FIG. 1A, the logging tool 102 is a downhole logging tool that operates while disposed in the wellbore 104. The example surface equipment 112 shown in FIG. 1A operates at or above the surface 106, for example, near the well head 105, to control the logging tool 102 and possibly other downhole equipment or other components of the well system 100. The example computing subsystem 110 can receive and analyze logging data from the logging tool 102. An NMR logging system can include additional or different features, and the features of an NMR logging system can be arranged and operated as represented in FIG. 1A or in another manner.

In some instances, all or part of the computing subsystem 110 can be implemented as a component of, or can be integrated with one or more components of, the surface equipment 112, the logging tool 102 or both. In some cases, the computing subsystem 110 can be implemented as one or more computing structures separate from the surface equipment 112 and the logging tool 102.

In some implementations, the computing subsystem 110 is embedded in the logging tool 102, and the computing subsystem 110 and the logging tool 102 can operate concurrently while disposed in the wellbore 104. For example, although the computing subsystem 110 is shown above the surface 106 in the example shown in FIG. 1A, all or part of the computing subsystem 110 may reside below the surface 106, for example, at or near the location of the logging tool 102.

The well system 100a can include communication or telemetry equipment that allows communication among the computing subsystem 110, the logging tool 102, and other components of the NMR logging system 108. For example, the components of the NMR logging system 108 can each include one or more transceivers or similar apparatus for wired or wireless data communication among the various components. For example, the NMR logging system 108 can include systems and apparatus for optical telemetry, wireline telemetry, wired pipe telemetry, mud pulse telemetry, acoustic telemetry, electromagnetic telemetry, or a combination of these and other types of telemetry. In some cases, the logging tool 102 receives commands, status signals, or other types of information from the computing subsystem 110 or another source. In some cases, the computing subsystem 110 receives logging data, status signals, or other types of information from the logging tool 102 or another source.

NMR logging operations can be performed in connection with various types of downhole operations at various stages in the lifetime of a well system. Structural attributes and components of the surface equipment 112 and logging tool 102 can be adapted for various types of NMR logging operations. For example, NMR logging may be performed during drilling operations, during wireline logging operations, or in other contexts. As such, the surface equipment 112 and the logging tool 102 may include, or may operate in connection with drilling equipment, wireline logging equipment, or other equipment for other types of operations.

In some examples, NMR logging operations are performed during wireline logging operations. FIG. 1B shows an example well system 100b that includes the NMR logging tool 102 in a wireline logging environment. In some example wireline logging operations, the surface equipment 112 includes a platform above the surface 106 equipped with a derrick 132 that supports a wireline cable 134 that extends into the wellbore 104. Wireline logging operations can be performed, for example, after a drill string is removed from the wellbore 104, to allow the wireline logging tool 102 to be lowered by wireline or logging cable into the wellbore 104.

In some examples, NMR logging operations are performed during drilling operations. FIG. 1C shows an example well system 100c that includes the NMR logging tool 102 in a logging while drilling (LWD) environment. Drilling is commonly carried out using a string of drill pipes connected together to form a drill string 140 that is lowered through a rotary table into the wellbore 104. In some cases, a drilling rig 142 at the surface 106 supports the drill string 140, as the drill string 140 is operated to drill a wellbore penetrating the subterranean region 120. The drill string 140 may include, for example, a kelly, drill pipe, a bottom hole assembly, and other components. The bottomhole assembly on the drill string may include drill collars, drill bits, the logging tool 102, and other components. The logging tools may include measuring while drilling (MWD) tools, LWD tools, and others.

In some example implementations, the logging tool 102 includes an NMR tool for obtaining NMR measurements from the subterranean region 120. As shown, for example, in FIG. 1B, the logging tool 102 can be suspended in the wellbore 104 by a coiled tubing, wireline cable, or another structure that connects the tool to a surface control unit or other components of the surface equipment 112. In some example implementations, the logging tool 102 is lowered to the bottom of a region of interest and subsequently pulled upward (e.g., at a substantially constant speed) through the region of interest. As shown, for example, in FIG. 1C, the logging tool 102 can be deployed in the wellbore 104 on jointed drill pipe, hard wired drill pipe, or other deployment hardware. In some example implementations, the logging tool 102 collects data during drilling operations as it moves downward through the region of interest. In some example implementations, the logging tool 102 collects data while the drill string 140 is moving, for example, while it is being tripped in or tripped out of the wellbore 104.

In some implementations, the logging tool 102 collects data at discrete logging points in the wellbore 104. For example, the logging tool 102 can move upward or downward incrementally to each logging point at a series of depths in the wellbore 104. At each logging point, instruments in the logging tool 102 perform measurements on the subterranean region 120. The measurement data can be communicated to the computing subsystem 110 for storage, processing, and analysis. Such data may be gathered and analyzed during drilling operations (e.g., during logging while drilling (LWD) operations), during wireline logging operations, or during other types of activities.

The computing subsystem 110 can receive and analyze the measurement data from the logging tool 102 to detect properties of various subsurface layers 122. For example, the computing subsystem 110 can identify the density, viscosity, porosity, material content, or other properties of the subsurface layers 122 based on the NMR measurements acquired by the logging tool 102 in the wellbore 104.

In some implementations, the logging tool 102 obtains NMR signals by polarizing nuclear spins in the formation 120 and pulsing the nuclei with a radio frequency (RF) magnetic field. Various pulse sequences (i.e., series of radio frequency pulses, delays, and other operations) can be used to obtain NMR signals, including the Can Purcell Meiboom Gill (CPMG) sequence (in which the spins are first tipped using a tipping pulse followed by a series of refocusing pulses), the Optimized Refocusing Pulse Sequence (ORPS) in which the refocusing pulses are less than 180°, a saturation recovery pulse sequence, and other pulse sequences.

The acquired spin-echo signals (or other NMR data) may be processed (e.g., inverted, transformed, etc.) to a relaxation-time distribution (e.g., a distribution of transverse relaxation times T₂ or a distribution of longitudinal relaxation times T₁), or both. The relaxation-time distribution can be used to determine various physical properties of the formation by solving one or more inverse problems. In some cases, relaxation-time distributions are acquired for multiple logging points and used to train a model of the subterranean region. In some cases, relaxation-time distributions are acquired for multiple logging points and used to predict properties of the subterranean region.

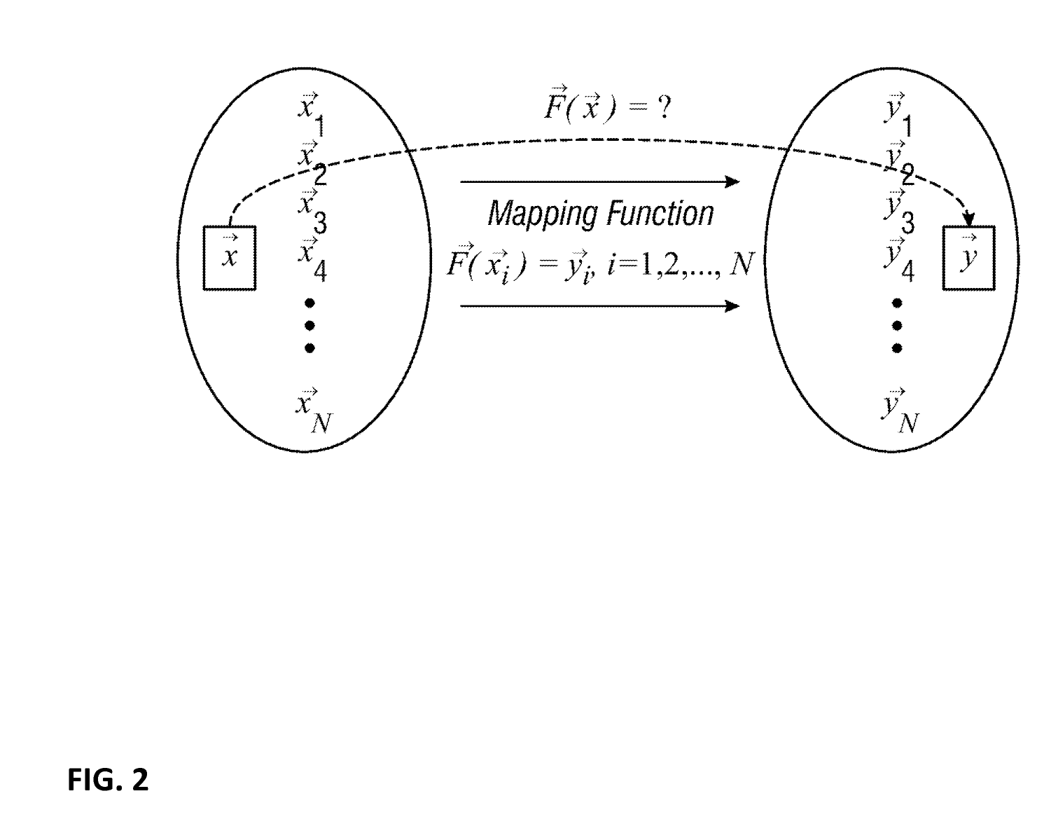

Inverse problems encountered in well logging and geophysical applications may involve predicting the physical properties of some underlying system given a set of measurements (e.g., a set of relaxation-time distributions). Referring to FIG. 2, consider a database having a set of distinct input data \vec{xᵢ}∈Rⁿ (i.e., the inputs are n-dimensional vectors) and a set of corresponding outputs \vec{yᵢ}∈R^{m}, for i=1, . . . , N, where N is the number of cases in the database. The different cases in the database represent different states of the underlying physical system. In this notation, \vec{yᵢ} values represent samples of the function that one wants to approximate (e.g., by a model), and \vec{xᵢ} values are the distinct points at which the function is given. The database is used to construct a mapping function such that, given measurements \vec{x} that are not in the database, one can predict the properties F(\vec{x}) of the physical system that is consistent with the measurements. The mapping function can solve the inverse problem of predicting the physical properties of the system from the measurements.

Mapping functions can be used to solve the inverse problem of predicting the viscosity of fluid (e.g., oil, etc.) in a subterranean formation based on measurements obtained using NMR. In some cases, mapping can be used to develop a correlation that links fluid viscosity measurements with NMR measurements. A mapping function can be developed, for example, based on training data obtained through in situ measurements or ex situ measurements. The developed mapping function can then be used to predict the viscosity of oil based on subsequent in situ measurements.

In some implementations, a mapping function can used to predict the viscosity of a fluid in a subterranean formation based on T₁ or T₂ distributions obtained using NMR. As an example, for particular types of fluids (e.g., oils and other hydrocarbons), an inverse relationship exists between the T₂ relaxation time (or the geometric mean of the T₂ relaxation time, T_{2GM}) of the fluid and its viscosity. Accordingly, in some cases, it may be possible to predict a fluid's viscosity by measuring the fluid's T₂ relaxation time or T_{2GM}. In some cases, however, accurately determining a fluid's T₂ or T_{2GM} may be difficult. For instance, in some implementations (e.g., when examining heavy oil), NMR signals obtained from bound water might overlap in the relaxation time spectrum with NMR signals obtained from the fluid of interest. This overlap may make it difficult to isolate the NMR signals obtained from each, and can interfere with accurate estimation of the viscosity of the fluid of interest. Further, the NMR inversion process can often introduce additional artifacts, particularly when the relaxation time of the fluid is short or the signal-to-noise ratio (SNR) of the NMR signal is low, and can further interfere with accurate estimation.

In some implementations, the viscosity of a fluid can be predicted using the apparent hydrogen index measured using NMR. This viscosity prediction technique can be used instead of or in addition to viscosity prediction techniques based on T₂ or T_{2GM} measurements.

Hydrogen index is a parameter that expresses the amount of hydrogen in a sample, divided by the amount of hydrogen in an equal volume of pure water. For example, the hydrogen index of a particular substance can be calculated by finding the ratio of the concentration of hydrogen atoms per volume (e.g., cm³), to that of pure water to a given temperature (e.g., 75° C.). An inferred or “apparent” hydrogen index can be estimated in a variety of ways. In some cases, an NMR tool, for instance the logging tool 102, acquires multiple echo-time (TE) data of fluid samples. Multiple NMR signals are acquired in order to produce multiple relaxation-time distributions, each corresponding to a particular TE. Various pulse sequences (i.e., series of radio frequency pulses) can be used to obtain NMR signals, including the Carr Purcell Meiboom Gill (CPMG) sequence (in which the spins are first tipped using a tipping pulse followed by a series of refocusing pulses), the Optimized Refocusing Pulse Sequence (ORPS) (in which the refocusing pulses are less than 180°), and other pulse sequences.

The NMR signals can be converted into relaxation-time distributions. NMR signal inversion is dependent on the inter-echo spacing TE used to acquire the signal. The inter-echo spacing can be controlled by the NMR measurement system, for example, by controlling the duration of the pulses and the timing between pulses in the pulse sequence executed by the NMR measurement system.

In some examples, each NMR signal is a spin-echo train that includes a series of multi-exponential decays, and the relaxation-time distribution can be a histogram of the decay rates extracted from the spin-echo train. For example, in some implementations, the inter-echo spacing TE dictates the upper limit of the fast T₂ component that can be measured by a particular NMR system. For NMR signals acquired using a Carr Purcell Meiboom Gill (CPMG) pulse sequence, the decay of NMR signals can be described by a multi-exponential decay function. For example, an NMR signal can be described as multiple components resulting from multiple difference relaxation times in the measured region. For example, the signal amplitude of the first echo may be expressed approximately by:

$$φ ( t = T E ) = {\sum }_{i = 1}^{N} {φ}_{i} exp ( - \frac{T E}{{T}_{2 i}} ) .$$

Here, each of the components has a respective amplitude of φᵢ and a characteristic relaxation time T₂ᵢ.

In some cases, some of the components (i<k) (those having the shortest relaxation times T₂ᵢ) decay too quickly to produce a measureable signal at the echo time, and the measurable signal amplitude is:

$${\sum }_{i = k}^{N} {φ}_{i} ,$$

and the total signal is:

$${\sum }_{i = 1}^{N} {φ}_{i} ,$$

Accordingly, in some cases, the apparent hydrogen index (HIₐₚₚ) can be expressed as:

$$H {I}_{app} ( T E ) = \frac{{\sum }_{i = k ( TE )}^{N} {φ}_{i}}{{\sum }_{i = 1}^{N} {φ}_{i}} .$$

The T₂ distribution can then be described as:
φ:{φᵢ vs. T₂ᵢ, where i=1:N}.
   For data acquired with a finite TE, the apparent T₂ distribution can be described as:
φₐₚₚ(TE):{φᵢ vs. T₂ᵢ, where i=k:N and φᵢ=0 for i<k}.
   Multiple TEs can be used to acquired NMR data, and can result in multiple apparent T₂ distributions, each corresponding to a particular TE.

In some implementations, apparent hydrogen index can be determined by conducting two different NMR experiments. For example, two NMR experiments can be conducted, each using different TEs. In another example, two NMR experiments can be conducted, one using a particular TE of choice, and one conducted as a free induction decay (FID) experiment. The apparent hydrogen index can be deduced from the difference in NMR signal amplitudes between the two experiments.

In another example, apparent hydrogen index can be determined by using other types of logging data (e.g., resistivity logging data, etc.). For example, in some cases, other information may be available regarding a particular subterranean region, such as the region's density porosity φ_{D}, NMR porosity φ_{NMR}, and oil saturation s₀. This information can be obtained, for example, using an NMR tool and/or other logging tools, such as dielectric tools. In an example, the apparent hydrogen index can be calculated as:

$$H {I}_{app} = 1 - \frac{ {φ}_{D} - {φ}_{NMR}}{{φ}_{D} * {s}_{0}} .$$

In some implementations, other methods of determining apparent hydrogen index can be used, either in addition to or instead of the example techniques described above.

Apparent hydrogen index measurements can be used to develop a model that describes the relationship between a fluid's apparent hydrogen index and its viscosity. For example, in some implementations, a collection of measured apparent hydrogen index values can be obtained for a variety of regions (e.g., regions that include different types of oil having different viscosities), under different conditions (e.g., measured using different NMR sequences or similar sequences having different TEs). Each measured apparent hydrogen index value is then paired with a viscosity measurement of the region, and a mathematical function can be computed that approximates the relationship between a measured apparent hydrogen index value and its corresponding viscosity measurement. The function can be, for example, a linear function, a quadratic function, a cubic function, or another type of function.

In some instances, viscosity measurements can be obtained using techniques other than NMR. For the purposes of model training, these measured viscosity values can be obtained independently from the NMR measurements. In some cases, these viscosity values are obtained ex situ using any of a variety of viscosity measurement instruments and techniques. For example, in some implementations, a core sample from the formation is removed from the earth's surface, and fluid from the core sample is measured using a viscometer or another type of measurement system. In another example, a reservoir fluid sample is removed from the earth's surface, and the reservoir fluid sample is measured using a viscometer or another type of measurement system.

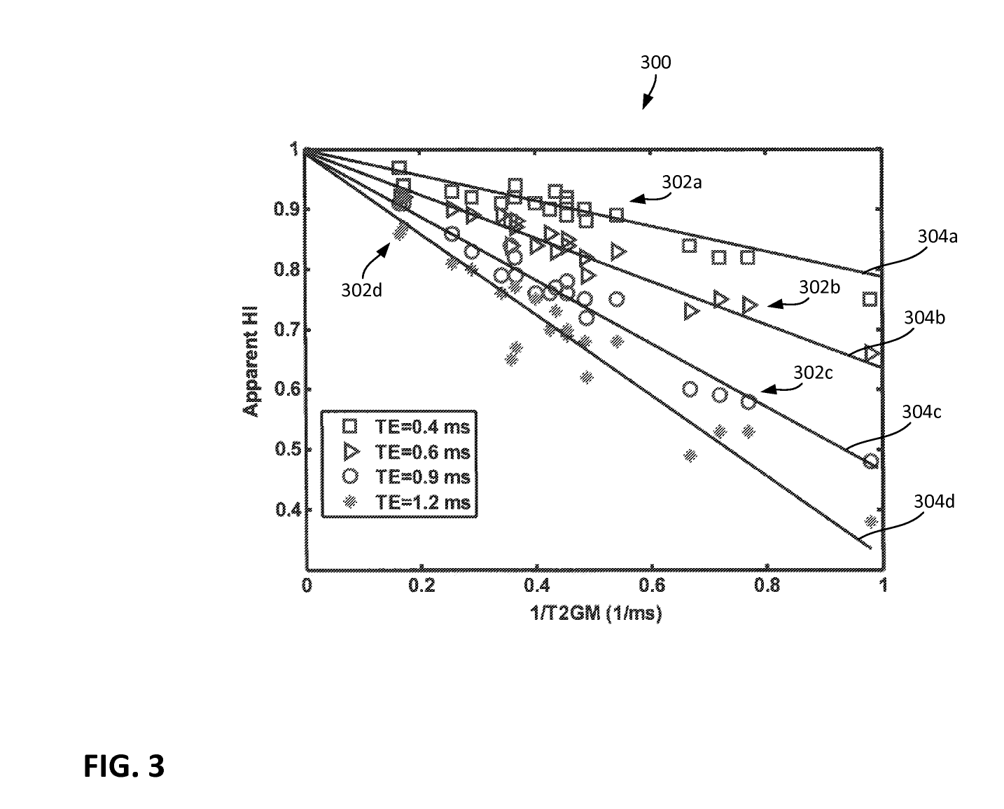

FIG. 3 shows an example plot 300 of apparent hydrogen index values versus 1/T_{2GM}. The data in the plot 300 demonstrates aspects of an example relationship between a fluid's measured apparent hydrogen index values, its viscosity as measured by an independent technique, and the TE of the NMR sequence to acquire the data. In this example, for each of four different TEs (indicated by a different series of icons 302a-d), a function (shown as lines 304a-d, respectively) approximates the relationship between the measured hydrogen index of a fluid and its viscosity. In some cases, the parameters of each function 304a-d can be determined using linear regression analysis of each series of measured apparent hydrogen index values and their corresponding viscosities. In some implementations, functions can be determined using other fitting methods, for example, using quadratic regression, cubic regression, or any other fitting method. As an example, in some cases, a fitted function 304a-d can be a quadratic equation in the form:

η=aHIₐₚₚ²+bHIₐₚₚ+c,

where η is a variable representing the subterranean fluid viscosity, HIₐₚₚ is a variable representing the apparent hydrogen index, and a, b, and c are constants. In some implementations, constants of a fitting function can be calculated empirically. As an example, for a TE of 0.9 ms, a can be 75010, b can be 150300, and c can be 44630. Other combinations of fitting functions and constants can be used, depending on the implementation.

In some implementations, a model can be developed that relates a region's apparent hydrogen index to a parameter that indirectly corresponds to the region's viscosity. For example, a developed model might describe a linear correlation between a region's apparent hydrogen index and its T_{2GM} value, where the relationship between T_{2GM} and viscosity η is approximated as:

$$\frac{1}{{T}_{2 GM}} = α * η ,$$

where α is a constant. In this example, the apparent hydrogen index is linearly proportional to 1/T_{2GM}, which in turn is roughly linearly proportional to viscosity. Accordingly, in this example, an apparent hydrogen index value would be approximately linearly correlated to viscosity. Other parameters can be used, either in addition or instead T_{2GM}, in some implementations.

While NMR measurements can be obtained using several different TEs during model training, a subsequent viscosity prediction does not necessarily require NMR measurements having every one of these TEs. As an example, after a model has been developed using multiple TEs, a user can estimate the viscosity of an unknown region using NMR measurements obtained using a subset of these TEs (e.g., one TE, two TEs, or some other subset of the TEs used during model development). Accordingly, once a model is developed for a particular set of TEs, the viscosity of an unknown region can be estimated by subsequently measuring the region's apparent hydrogen index using at least one of these TEs.

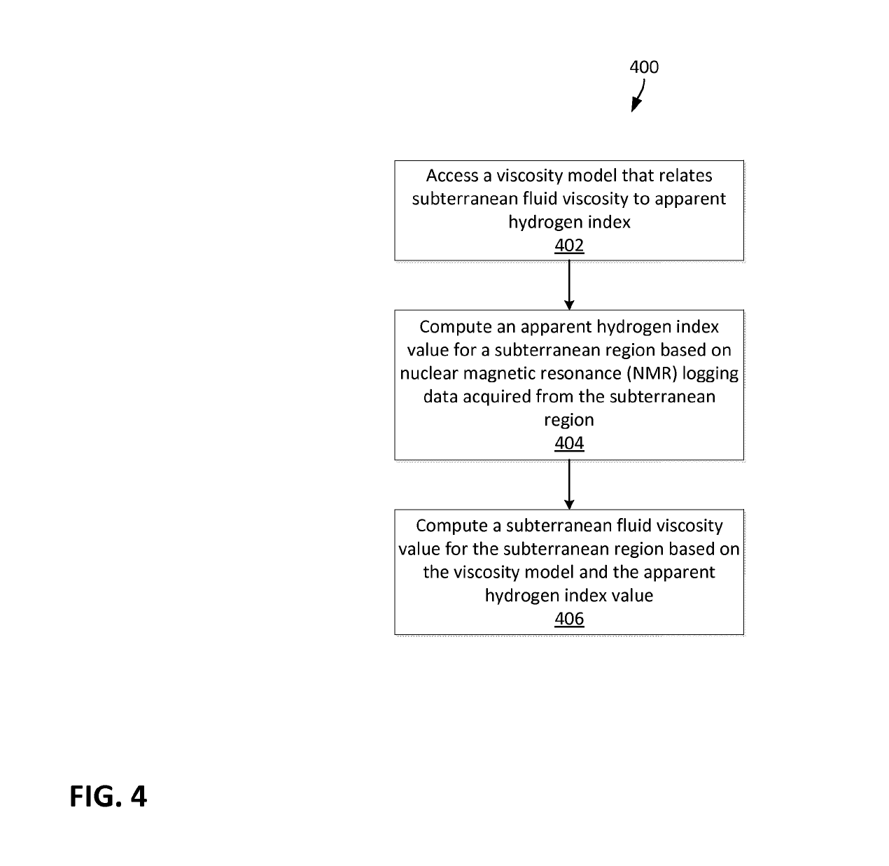

An example process 400 for estimating the viscosity of a subterranean fluid based on NMR logging data is shown in FIG. 4. Process 400 includes accessing a viscosity model that relates a subterranean fluid viscosity variable to an apparent hydrogen index variable (402). For example, the model may include an equation (e.g., η=aHIₐₚₚ²+bHIₐₚₚ+c, or another equation) or a database that specifies a relationship (e.g., a linear relationship, a polynomial relationship, etc.) or correlation among respective variables that represent the subterranean fluid viscosity, the apparent hydrogen index, and others. In an example implementation, one or more models are developed (e.g., in a manner similar to the implementations described above), each developed model is stored for future retrieval (e.g., on a storage module of a computing device), and a suitable model is accessed for use in process 400. A model can be selected based on a variety of factors. For example, a particular model might be selected if it was developed using particular training data (e.g., measurements conducted on materials presumed to be similar to that of the unknown region, or measurements acquired using a particular TE). As another example, a particular model might be selected based on its predictive range (e.g., if the model's predictive range encompasses parameter values presumed to be similar to that of the unknown region).

Process 400 also includes computing an apparent hydrogen index value for a subterranean region based on NMR logging data acquired from the subterranean region of interest (404). In an example implementation, one of more NMR experiments can be conducted on the subterranean region of interest, and based on these measurements, the apparent hydrogen index value for a region of interest can be computed (e.g., in a manner similar to the implementations described above).

Once a model has been selected and an apparent hydrogen index value has been computed for the subterranean region of interest, a subterranean fluid viscosity value for the subterranean region is computed based on the selected viscosity model and the apparent hydrogen index value (406). In an example implementation, the viscosity can be calculated by inputting the computed hydrogen index value into a mathematical function that describes the correlation between an apparent hydrogen index value and a corresponding predicted viscosity value for NMR logging data having a particular TE (e.g., in a manner similar to the implementations described above).

In some examples, as described above, viscosity can be estimated by using NMR logging data having any one of multiple TEs. The optimal (or otherwise acceptable) TE can differ depending on the application. For example, a minimal TE may be preferred in some cases, as it can provide the least signal loss and fastest sampling rate. With minimal TE, however, because the signal loss is small, in some cases the variation in apparent hydrogen index in the viscosity range of interest might be too small for the apparent hydrogen index to be used reliably as the sole correlation parameter for viscosity prediction. For instance, in the example shown in FIG. 3, using a TE of 0.4 ms (indicated by icon series 302a and function line 304a) results in a relatively limited range of possible apparent hydrogen index values within the viscosity range of interest (e.g., an apparent hydrogen index range of approximately 0.75 to 0.96). In contrast, using a TE of 1.2 ms (indicated by icon series 302d and function line 304d) results in a wider range of possible apparent hydrogen index values within the viscosity range of interest (e.g., an apparent hydrogen index range of approximately 0.38 to 0.87). A wider range of possible apparent hydrogen index values might be beneficial in some cases, as it provides a broader overall dynamic range, and may increase the predictive resolution of the model. A maximal TE, however, may be unsuitable in some cases, as the signal loss may be undesirably high (e.g., at the upper end of the viscosity range of interest), and can result in greater uncertainty for each apparent hydrogen index measurement (which can potentially result in poor viscosity prediction).

Accordingly, a TE can be chosen for a particular application. A TE can be determined in a variety of ways. In an example, several possible TEs can be measured, and a suitable TE can be identified and used for viscosity prediction. The suitable TE can be identified, for example, by computing the standard deviation, σ, of the predicted viscosity η_{predicted}, as compared to the measured viscosity, η_{measured}. For instance, this can be calculated using the equation:

$$σ = \sqrt{\frac{1}{N} \sum {( \frac{{η}_{predicted} - {η}_{measured}}{{η}_{measured}} )}^{2}} ,$$

and a particular TE can be selected such that the standard deviation meet certain criteria. As an example, a TE that results in the lowest standard deviation might be selected from a group of possible TEs.

In another example, the relative error of the apparent hydrogen index can be compared over a range of hydrogen index values. For example, referring to the example shown in FIG. 2, a user might specify that the error in porosity should be no more than approximately 1 porosity unit (p.u.) in a 30 p.u. formation. For the example 1.2 ms TE data shown in FIG. 2, the maximum error of apparent hydrogen index will be 1 p.u./(30 p.u.*0.38)=0.888, where 0.38 is the lowest measured apparent hydrogen index value for a TE of 1.2 ms. For a range of hydrogen index values from 0.38 (the lowest measured apparent hydrogen index value) to 0.87 (the highest measured hydrogen index value), this represents 18.0% error. Using similar corresponding calculations, for 0.9, 0.6, and 0.4 ms TE data, the error will be 17.4%, 18.3%, and 22.2%, respectively. Accordingly, in this example, a larger TE of 0.9 ms might be beneficial over a TE of 0.4 ms, as it corresponds to a lower relative error. Thus, depending on the application, the lower possible TE or the highest possible TE might not be the most suitable TE for prediction.

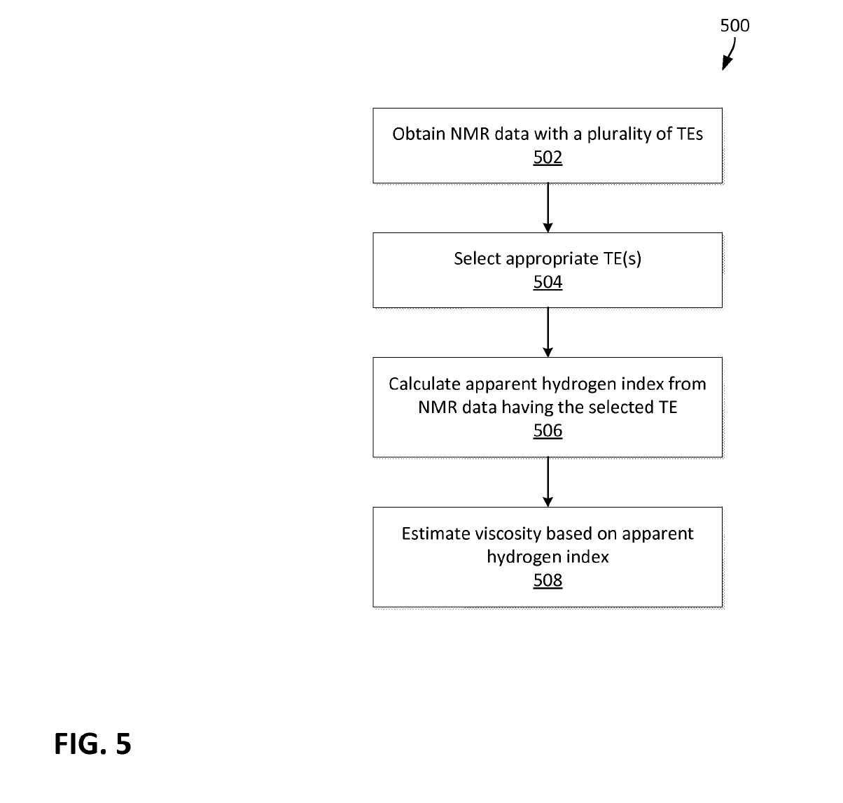

An example process 500 for selecting an appropriate TE and estimating the viscosity of a subterranean region is shown in FIG. 5. Process 500 includes obtaining NMR data having a plurality of TEs from a subterranean region of interest (502). In some implementations, the NMR data can be obtained using a CMPG sequence, for example as described above. In some implementations, the collected NMR data includes data corresponding to one or more echoes of a CMPG sequence (e.g., one echo, two echoes, three echoes, and so forth).

After NMR data is collected, one or more appropriate TEs are selected (504). In some implementations, an appropriate TE can be selected using one or more of the example implementations described above. As an example, an appropriate TE can be selected by computing, for each possible TE, the standard deviation of the predicted viscosity, and comparing it to the measured viscosity. As another example, an appropriate TE can be selected by comparing, for each possible TE, the relative error of the apparent hydrogen index values over a range of hydrogen index values. In another example, an appropriate TE can be selected based on a determining of the sensitivity of the change of apparent hydrogen index as a function of viscosity in the viscosity range of interest.

Once appropriate TEs are selected, apparent hydrogen values are calculated based on NMR data obtained using the selected TEs (506). Apparent hydrogen values can be calculated using one or more of the implementations described above. As an example, apparent hydrogen values can be calculated using based solely on the collected NMR data, or it can be calculated based also on other logs or measurements (e.g., measurements made using dielectric tools).

The calculated apparent hydrogen values are then used as an input into a suitable viscosity model, resulting in an estimate of the viscosity of the subterranean region (508). A suitable model and corresponding function can be determined, for example, using one of more of the implementations described above.

The process 500 shown in FIG. 5 provides an example of how NMR data corresponding to a suitable TE can be used to predict the viscosity of a subterranean region. Other implementations are possible. For example, in some implementations, NMR data having multiple different TEs can be acquired for the subterranean region of interest, and an appropriate TE can be selected retrospectively (e.g., after the NMR data has been collected). Accordingly, in some cases, NMR data can be collected for multiple different TEs, but only a subset of the collected data might be used to make a viscosity estimate. In some implementations, the most appropriate TE can be determined prospectively (e.g., prior to the acquisition of NMR data for the subterranean region of interest). Accordingly, in some cases, NMR data of a pre-determined TE can be collected and used to make a viscosity estimate.

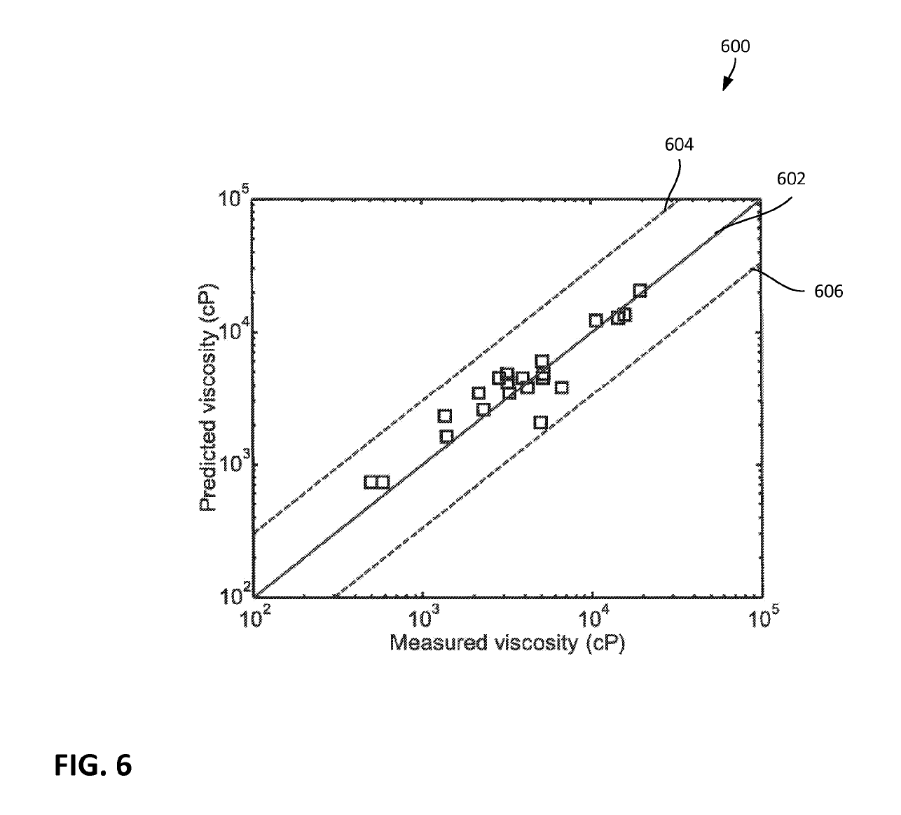

Referring to FIG. 6, plot 600 shows the viscosity values of several example subterranean regions predicted using the example implementations described above, and compares these predictions to independently measured viscosity values (e.g., measured using a viscometer). In this example, the relationship between measured viscosity and predicted viscosity is roughly linear (indicated by line 602), and the predicted viscosity is generally within a factor of three (indicated by lines 604 and 606) of the measured viscosity. In other examples, the relationship between the measured and predicted viscosity values can differ, as can the accuracy and precision of the viscosity predictions, depending on the application.

Some implementations of the subject matter and operations described in this specification can be implemented in digital electronic circuitry, or in computer software, firmware, or hardware, including the structures disclosed in this specification and their structural equivalents, or in combinations of one or more of them. Some embodiments of subject matter described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

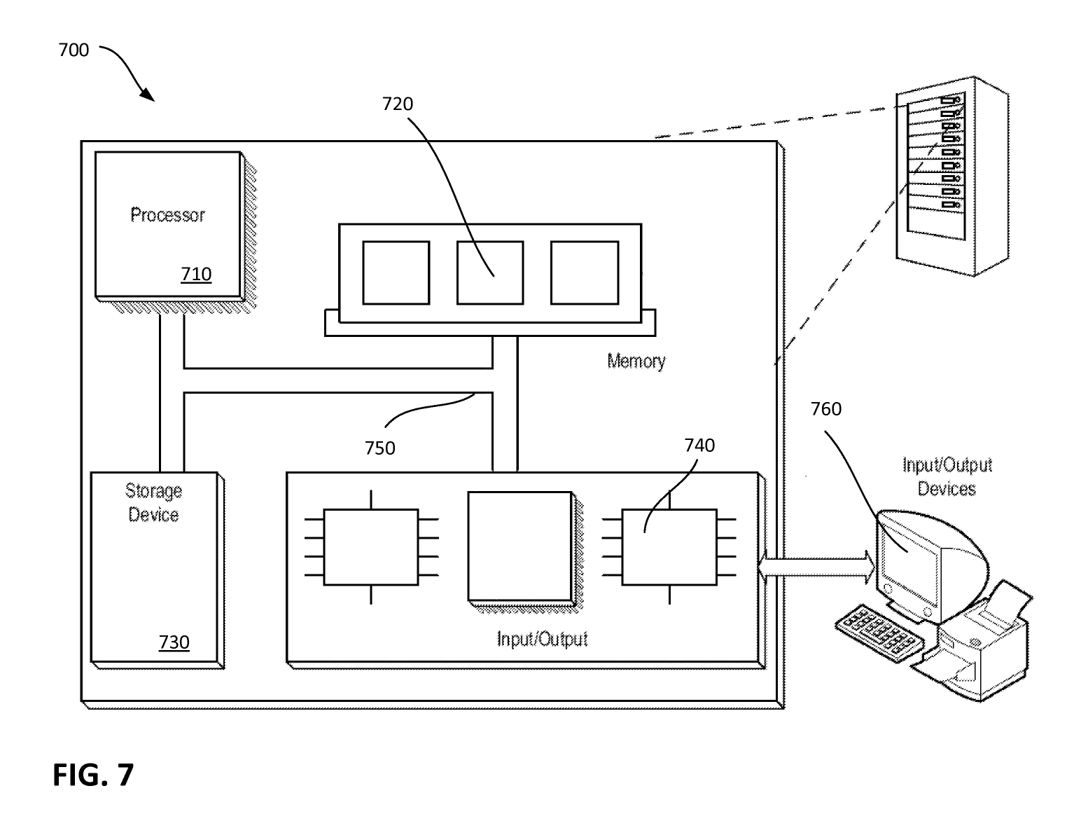

FIG. 7 shows an example computer system 700. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In some implementations, the processor 710 is a single-threaded processor, a multi-threaded processor, or another type of processor. The processor 710 is capable of processing instructions stored in the memory 720 or on the storage device 730. The memory 720 and the storage device 730 can store information within the system 700.

The input/output device 740 provides input/output operations for the system 700. In some implementations, the input/output device 740 can include one or more network interface devices, e.g., an Ethernet card; a serial communication device, e.g., an RS-232 port; and/or a wireless interface device, e.g., an 802.11 card, a 3G wireless modem, a 4G wireless modem, etc. In some implementations, the input/output device can include driver devices configured to receive input data and send output data to other input/output devices, e.g., keyboard, printer and display devices 760. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of examples have been described. Nevertheless, it will be understood that various modifications can be made. Accordingly, other implementations are within the scope of the following claims.

1. A method of determining subterranean fluid viscosity based on nuclear magnetic resonance (NMR) logging data, the method comprising:
accessing a viscosity model that relates a subterranean fluid viscosity variable to an apparent hydrogen index variable;
computing an apparent hydrogen index value for a subterranean region based on nuclear magnetic resonance (NMR) logging data acquired from the subterranean region; and
computing a subterranean fluid viscosity value for the subterranean region based on the viscosity model and the apparent hydrogen index value.

2. The method of claim 1, wherein the viscosity model models subterranean fluid viscosity as a function of the apparent hydrogen index variable, and the subterranean fluid viscosity value is computed by substituting the apparent hydrogen index value into the function.

3. The method of claim 2, comprising:
selecting a subset of the NMR logging data having a specified inter-echo time; and
computing the apparent hydrogen index value based on the selected subset of the NMR logging data.

4. The method of claim 3, wherein the model models subterranean fluid viscosity as a function of the apparent hydrogen index variable for NMR logging data having the specified inter-echo time.

5. The method of claim 2, further comprising generating the viscosity model, wherein generating the viscosity model includes fitting one or more parameters of the function to test data.

6. The method of claim 2, wherein the function comprises at least one of a linear function, a cubic function, or a quadratic function.

7. The method of claim 1, comprising computing the apparent hydrogen index value based on the NMR logging data and other logging data.

8. The method claim 1, further comprising acquiring the NMR logging data by operation of a downhole NMR logging instrument.

9. A system comprising:
a nuclear magnetic resonance (NMR) measurement system; and
a computing system comprising:
data processing apparatus; and
memory storing computer-readable instructions that, when executed by the data processing apparatus, cause the data processing apparatus to perform operations comprising:
accessing a viscosity model that relates a subterranean fluid viscosity variable to an apparent hydrogen index variable;
computing an apparent hydrogen index value for a subterranean region based on NMR logging data acquired from the subterranean region by the NMR measurement system; and
computing a subterranean fluid viscosity value for the subterranean region based on the viscosity model and the apparent hydrogen index value.

10. The system of claim 9, wherein the viscosity model models subterranean fluid viscosity as a function of the apparent hydrogen index variable, and the subterranean fluid viscosity value is computed by substituting the apparent hydrogen index value into the function.

11. The system of claim 10, wherein the operations further comprise:
selecting a subset of the NMR logging data having a specified inter-echo time; and
computing the apparent hydrogen index value based on the selected subset of the NMR logging data.

12. The system of claim 11, wherein the model models subterranean fluid viscosity as a function of the apparent hydrogen index variable for NMR logging data having the specified inter-echo time.

13. The system of claim 10, wherein the operations further comprise generating the viscosity model, wherein generating the viscosity model includes fitting one or more parameters of the function to test data.

14. The system of claim 9, wherein the operations further comprise computing the apparent hydrogen index value based on the NMR logging data and other logging data.

15. A non-transitory computer-readable medium storing instructions that, when executed by data processing apparatus, cause the data processing apparatus to perform operations comprising:
accessing a viscosity model that relates a subterranean fluid viscosity variable to an apparent hydrogen index variable;
computing an apparent hydrogen index value for a subterranean region based on nuclear magnetic resonance (NMR) logging data acquired from the subterranean region; and
computing a subterranean fluid viscosity value for the subterranean region based on the viscosity model and the apparent hydrogen index value.

16. The computer-readable medium of claim 15, wherein the viscosity model models subterranean fluid viscosity as a function of the apparent hydrogen index variable, and the subterranean fluid viscosity value is computed by substituting the apparent hydrogen index value into the function.

17. The computer-readable medium of claim 16, wherein the operations comprise:
selecting a subset of the NMR logging data having a specified inter-echo time; and
computing the apparent hydrogen index value based on the selected subset of the NMR logging data.

18. The computer-readable medium of claim 17, wherein the model models subterranean fluid viscosity as a function of the apparent hydrogen index variable for NMR logging data having the specified inter-echo time.

19. The method of claim 3, further comprising generating the viscosity model, wherein generating the viscosity model includes fitting one or more parameters of the function to test data.

20. The method of claim 4, further comprising generating the viscosity model, wherein generating the viscosity model includes fitting one or more parameters of the function to test data.

21. The system of claim 11, wherein the operations further comprise generating the viscosity model, wherein generating the viscosity model includes fitting one or more parameters of the function to test data.

22. The system of claim 12, wherein the operations further comprise generating the viscosity model, wherein generating the viscosity model includes fitting one or more parameters of the function to test data.
